(19) United States
(12) Patent Application Publication
(10) Pub. No.: US 2003/0194906 A1
(43) Pub. Date: Oct. 16, 2003

(54) Lighted accessory connector

(76) Inventors: David M. Arkin, Glenview, IL (US); Charles A. Jacobs, Barrington, IL (US)

Correspondence Address: BARNES & THORNBURG, 11 SOUTH MERIDIAN, INDIANAPOLIS, IN, 46204

(21) Appl. No.: 10/121,547

(22) Filed: Apr. 12, 2002

(51) Int. Cl. H01R 3/00

(52) U.S. Cl. 439/490

(57) ABSTRACT

A lighted accessory connector includes a first end connected to a conductor cable and configured for connection to a voltage source, and a second opposite end connected to the conductor cable and configured for connection to an electrical device. The second end of the connector includes a light source that automatically illuminates upon connection of the first end to the voltage source, and is operable to cast light outwardly away from the second end and beyond an electrical terminal structure extending from the second end to facilitate connection of the second end to an electrical port of the electrical device, and to aid in locating the second end, in an otherwise dark environment. In one embodiment, the light source is mounted within the second end, and is operable to transmit light therethrough. Alternatively, the light source may be mounted to a top, bottom or side portion of the second end.

### FIELD OF THE INVENTION

The present invention relates generally to electrical connectors for connecting electrical devices to voltage sources, and more specifically to such connectors incorporating a light source at one end.

### BACKGROUND AND SUMMARY OF THE INVENTION

Mobile electrical devices such as cellular telephones, notebook computers, electronic entertainment devices and the like are well-known in the art. Some such devices include one or more on-board batteries which are, in some cases, rechargeable via a wired connection to a suitable voltage source. Others do not include on-board batteries, and therefore require a wired connection to a voltage source to provide electrical power thereto. In either case, the mobile device typically includes an electrical connection port configured to receive one end of an accessory connector having an opposite end configured for connection to a suitable voltage source.

While connection of such an accessory connector to an electrical device is a relatively simple task under well-lighted conditions, it is considerably more difficult under dark ambient conditions such as may occur in a motor vehicle at night or within an unlit house or business. What is therefore needed is an accessory connector incorporating a light source to aid in locating the device connecting end of the accessory connector and facilitate connection of the accessory connector to the electrical connection port of an electrical device. The present invention provides for such a lighted accessory connector.

These and other objects of the present invention will become more apparent from the following description of the preferred embodiments.

### BRIEF DESCRIPTION OF THE DRAWINGS

FIG. 1 is a diagrammatic illustration of one preferred embodiment of a lighted accessory connector, in accordance with the present invention.

FIG. 2A is a diagrammatic illustration of one preferred embodiment of the voltage source-connecting end of the accessory connector of FIG. 1, configured for connection to a vehicle lighter socket, in accordance with the present invention.

FIG. 2B is a diagrammatic illustration of an alternate embodiment of the voltage source-connecting end of the accessory connector of FIG. 1, configured for connection to a standard AC voltage panel through an AC-DC converter, in accordance with the present invention.

FIG. 2C is a diagrammatic illustration of another alternate embodiment of the voltage source-connecting end of the accessory connector of FIG. 1, configured for connection to a lighter socket that is itself configured for connection to a standard AC voltage panel through an AC-DC converter, in accordance with the present invention.

FIG. 3 is a cross-sectional view of one preferred embodiment of the device-connecting end of the accessory connector of FIG. 1, configured to illuminate a connection port of the electrical device in accordance with the present invention.

FIG. 4 is a schematic diagram illustrating electrical connection of the components of FIG. 3.

FIG. 5 is a cross-sectional view of an alternate embodiment of the device-connecting end of the accessory connector of FIG. 1.

FIG. 6 is a front perspective view of yet another embodiment of the device-connecting end of the accessory connector of FIG. 1.

### DESCRIPTION OF THE PREFERRED EMBODIMENTS

For the purposes of promoting an understanding of the principles of the invention, reference will now be made to a number of preferred embodiments illustrated in the drawings and specific language will be used to describe the same. It will nevertheless be understood that no limitation of the scope of the invention is thereby intended, such alterations and further modifications in the illustrated embodiments, and such further applications of the principles of the invention as illustrated therein being contemplated as would normally occur to one skilled in the art to which the invention relates.

Referring now to FIG. 1, one preferred embodiment of a lighted accessory connector 10, in accordance with the present invention, is shown. Connector 10 includes an electrical cable 12 having a first end 14 configured for connection to a voltage source 16 and a second end 18 configured for connection to, and illumination of, a voltage supply port 20 of an electrical device 22. Electrical device 22 may be any device requiring connection to voltage source 16, either as a primary source of electrical power or as a charging source for one or more rechargeable batteries (not shown) carried by electrical device 22. Examples of electrical device 22 include, but are not limited to, cellular and land line telephones, laptop and notebook computers, personal digital assistants (PDAs), portable voice recorders, cameras, portable video recorders, portable audio recorders, portable video and audio playback devices, portable televisions, video games units, portable food coolers/heaters, fax machines, two-way radios, pagers, flashlights, electric razors, electric toothbrushes, and the like.

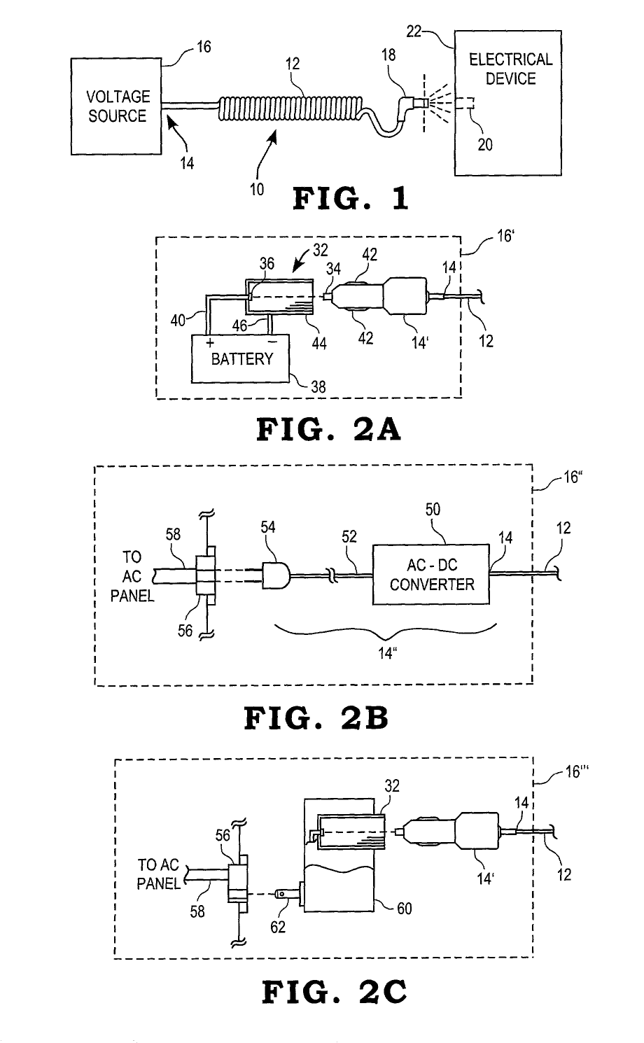

The first end 14 of the accessory connector 10 of the present invention may be configured for connection to any known DC voltage source, and some example configurations of connector end 14 and voltage source combinations are illustrated in FIGS. 2A-2C. Referring to FIG. 2A, a first example voltage source arrangement 16′ is illustrated, wherein the first end 14 of cable 12 is connected to a terminal structure 14′ configured for electrical connection to a conventional cigarette lighter socket 32. Terminal structure 14′ includes a first electrical terminal 34 electrically connected to a first electrical conductor of cable 12 (not shown), and a second electrical terminal, defined by terminal elements 42, electrically connected to a second electrical conductor of cable 12 (not shown). Complementarily configured lighter socket 32 includes a first electrical terminal 36 electrically connected to a positive terminal of a battery 38 via conductor 40, and a second electrical terminal, defined by the housing 44 of lighter socket 32, electrically connected to a negative terminal of the battery 38 via conductor 46. Terminal structure 14′ is configured to be engagingly received within lighter socket 32 such that the first electrical terminal 34 of structure 14′ electrically contacts the first electrical terminal 36 of socket 32 and the second terminal elements 42 electrically contact the socket housing 44, thereby supplying a DC voltage defined by battery 38 to the first and second conductors of cable 12 (not shown). In one embodiment, the lighter socket 32 and battery 38 are carried by a motor vehicle, wherein the lighter socket 32 is typically located in the dash area or other convenient location of the vehicle. Alternatively, battery 38 and lighter socket 32 may be provided as a portable voltage source.

Referring to FIG. 2B, a second example voltage source arrangement 16″ is illustrated, wherein the first end 14 of cable 12 is connected to a terminal structure 14″ configured for electrical connection to an AC voltage source via a wall socket 56. Terminal structure 14″ includes an AC-to-DC converter of known construction having a DC output end electrically connected to the first end 14 of cable 12, and an AC input end electrically connected to a conventional two (or three) prong plug 54 via conductor cable 52, wherein plug 54 is configured for electrical engagement with a conventional wall socket 56. Wall socket 56 is connected to an AC voltage source (not shown) via wiring 58, wherein the AC voltage source may typically be a conventional 120 volt or 240 volt electrical panel. In any case, AC voltage supplied to wall socket 56 is provided by plug 54 to the AC input of the AC-to-DC converter 50, which is operable to convert the AC voltage to a suitable DC voltage (e.g., 5, 7, 9 or 12 volts, or any other voltage required by the particular application of connector 10), and to provide this DC voltage to the electrical conductors carried by cable 12.

Referring to FIG. 2C, a third example voltage source arrangement 16′″ is illustrated, wherein the first end 14 of cable 12 is connected to the terminal structure 14′ described hereinabove with respect to FIG. 2A. In this embodiment, a lighter socket 32 is electrically connected to a DC output of an AC-to-DC converter unit 60 of known construction having an AC input electrically connected to a conventional two (or three) prong plug 62, wherein plug 62 is configured for electrical engagement with a conventional wall socket 56. Wall socket 56 is connected to an AC voltage source (not shown) via wiring 58, as described hereinabove with respect to FIG. 2B, wherein the AC voltage source may typically be a conventional 120 volt or 240 volt electrical panel. In any case, AC voltage supplied to wall socket 56 is provided by plug 62 to the AC input of the AC-to-DC converter 60, which is operable to convert the AC voltage to a suitable DC voltage (e.g., 5, 7, 9 or 12, volts or any other voltage required by the particular application of connector 10), and to provide this DC voltage to lighter socket 32. The terminal structure 14′ may be received within lighter socket 32, as described hereinabove with respect to FIG. 2A, to supply the DC voltage provided by converter 60 to the electrical conductors carried by cable 12.

It is to be understood that the connector end 14 and voltage source configurations shown and described with respect to FIGS. 2A-2C are provided only by way of example. Those skilled in the art will recognize other voltage source configurations and techniques for supplying a suitable DC voltage to the first end 14 of the accessory connector 10 of the present invention, and such other voltage source configurations and techniques are intended to fall within the scope of the present invention.

In accordance with the present invention, the second end 18 of the accessory connector 10 is configured to cast light away therefrom in a manner that illuminates an area directly in front and to the side of the electrical terminal structure of end 18. The second end 18 of the accessory connector 10 may accordingly be used as a light source to illuminate the electrical connection port 20 of electrical device 22 and thereby facilitate guiding of the end 18 of the accessory connector 10 into electrical engagement with port 20. Furthermore, the light emanating from the front and sides of the second end 18 of connector 10 serves as an aid in locating end 18 in an otherwise dark environment.

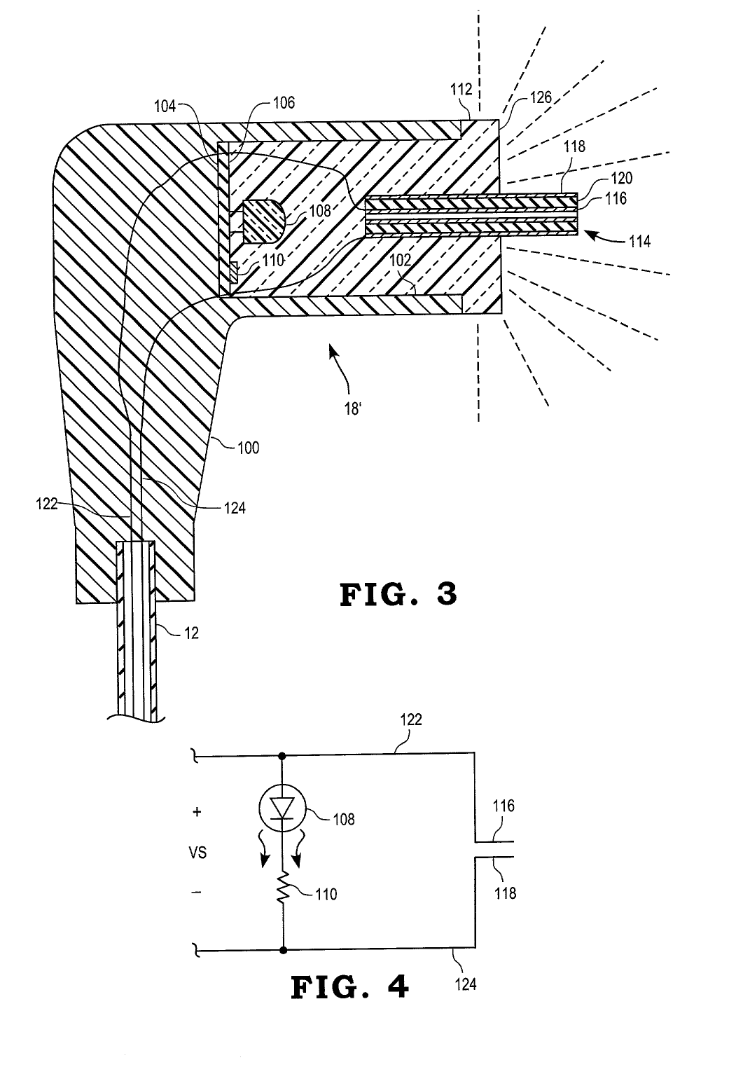

Referring now to FIG. 3, a cross-sectional view of one preferred embodiment 18′ of the second end 18 of the accessory connector 10 of FIG. 1, in accordance with the present invention, is shown. Embodiment 18′ includes a housing 100 receiving the conductor cable 12 at one end and defining a terminal structure 114 at an opposite end. In one embodiment, housing 100 is molded from a conventional plastic material having electrically insulative properties, although the present invention contemplates forming housing 100 from other known materials or combination of other known materials. In any case, housing 100 defines a well 102 therein terminating at a well bottom 104. A circuit board 106 is disposed at or near the bottom of well 104. A light source 108 and resistor 110 of are mounted to circuit board 106 in a known manner, such that light generated by light source 108 is directed generally toward terminal structure 114 and away from the bottom 104 of well 102. Light source 108, in one embodiment, includes at least one light emitting diode (LED) of known construction and operable to emit light of a suitable color when energized. The number and intensities of LEDs used to form light source 108 will generally be dictated by the light intensity requirements of the lighted accessory connector 10 of the present invention, taking into consideration any thermal and/or power dissipation requirements, as well as space restrictions within housing 100. Resistor 110 is also of known construction and may be provided in the form of a conventional discrete resistor having wire terminals extending therefrom, in the form of a conventional chip resistor suitable for surface mounting to circuit board 106, or in any other known form. The value of resistor 110 will generally be dictated by the light emission intensity requirement for light source 108, as well as the DC voltage level supplied by conductor cable 12. Alternatively, the wire leads of light source 108 and a leaded embodiment of resistor 110 may be directly soldered or welded to wires 122 and 124 to form an electrical circuit for illuminating light source 108 without using circuit board 106.

Terminal structure 114, in the embodiment shown, includes an outer, hollow cylindrical conductor 118 surrounding an inner cylinder conductor 116 with an electrical insulator 120 disposed therebetween. Conductors, or terminals, 116 and 118 are formed of conventional electrically conductive materials, and insulator 120 is formed of a conventional electrically insulating material. In any case, terminal structure 114 extends at least partially into well 102, as shown. A light transmissive material 112 is disposed within well 104 and defines a connector end 126 having one end of terminal structure 114 extending therefrom. Light transmissive material 112 may be any known material operable to maintain the circuit board 106, if provided, the light source 108, the resistor 110 and terminal structure 114 in fixed positions, as shown, and to permit transmission of light therethrough. Light transmissive material 112 may be transparent, translucent, or at least partially opaque, and the choice of any such light transmission capability of material 112 will generally be dictated by the light intensity requirements of the particular application of the lighted accessory connector 10, taking into consideration the color and intensity of light source 108 as well as the configuration of housing 100.

In the embodiment shown in FIG. 3, the conductor cable 12 includes two wires 122 and 124 carrying a DC voltage supplied by voltage source 16. Wires 122 and 124 are connected to circuit board 106, to light source 108, resistor 110 and terminal structure 114 as illustrated in FIG. 4. Wire 122 is connected to the positive connection of voltage source 16, and wire 124 is connected to the negative connection thereto. Wire 122 is connected either indirectly via circuit board 106 or directly to the anode of LED 108 and to terminal 116 of terminal structure 114, and wire 124 is connected either indirectly via circuit board 106 or directly to one end of the resistor 110 and to terminal 118 of terminal structure 114. The opposite end of the resistor 110 is connected to the cathode of the LED 108. In operation, light source 108 is automatically illuminated upon connection of end 14 of the accessory connector 10 to voltage source 16, and remains illuminated until end 14 of connector 10 is disengaged from voltage source 16. While illuminated, light source 108 is operable to cast light through the light transmissive material 112 and outwardly away from end 126 about the terminal structure 114. Light emitted laterally from the end 126 of connector end 18′ thus illuminates an area outside of housing 110 in front of and beyond terminal structure 114, and may accordingly be used to illuminate the electrical port 20 of electrical device 22 to facilitate insertion of end 18 of connector 10 within port 20 in an otherwise dark environment. Furthermore, light emitted radially from the light transmissive material 112 adjacent to end 126 illuminates an area about housing 100 perpendicular to the longitudinal axis of terminal structure 114, which services as an aid in locating the connector end 18 of accessory connector 10 in an otherwise dark environment.

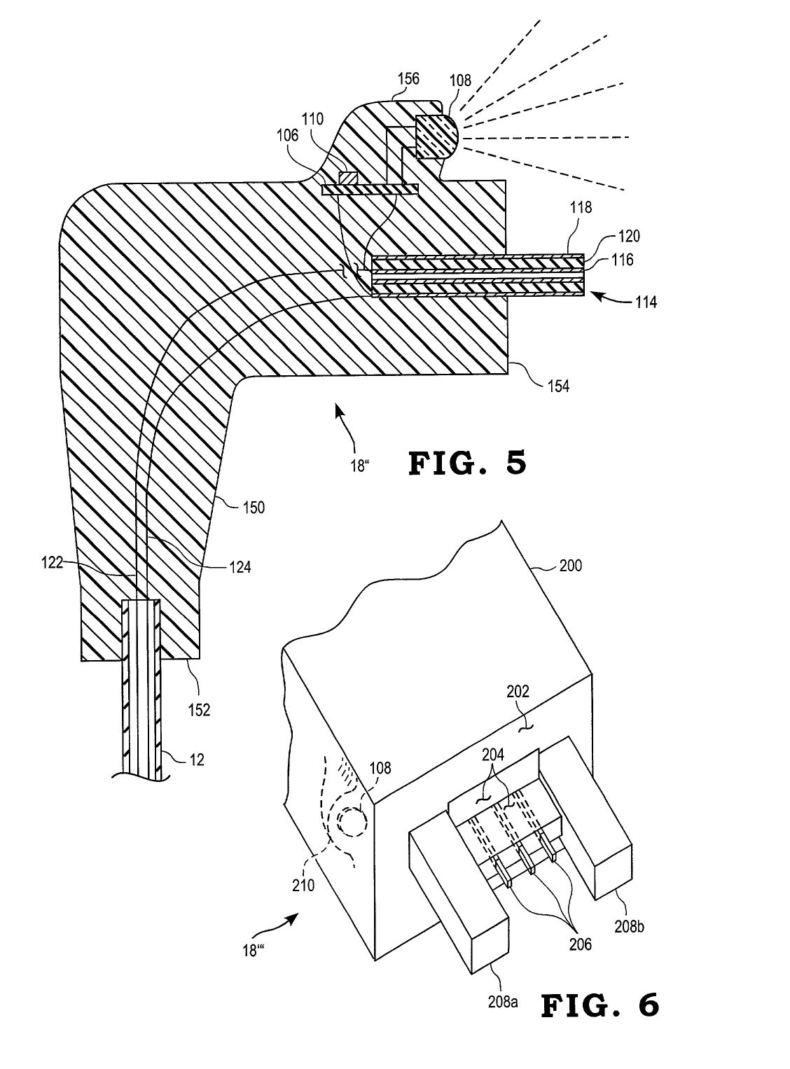

Referring now to FIG. 5, a cross-sectional view of an alternate embodiment 18″ of the second end 18 of the accessory connector 10 of FIG. 1, in accordance with the present invention, is shown. Embodiment 18″ is identical in some respects to embodiment 18′ illustrated in FIG. 3, and like numbers are therefore used to identify like elements. Embodiment 18″ includes a housing 150 receiving the conductor cable 12 at one end 152 and defining the terminal structure 114 at an opposite end 154. In one embodiment, housing 150 is molded from a conventional plastic material having electrically insulative properties, although the present invention contemplates forming housing 150 from other known materials or combination of other known materials. In any case, terminal structure 114 extends into the end 154 of housing 150, and wire 122 of cable 12 is connected to terminal 116, and wire 124 is connected to terminal 118.

Unlike embodiment 18′ illustrated in FIG. 3, the light source 108 is positioned above terminal structure 114 and oriented to cast light outward laterally, and to a lesser extent radially, from housing 154 and beyond terminal structure 114 as illustrated in FIG. 5. In this embodiment, a portion 156 of housing 150 surrounds and encapsulates at least a portion of light source 108 so as to properly align light source 108 relative to end 154 of housing 150 and terminal structure 114, and also to seal the interior of housing 150 from the outside environment. In the embodiment shown in FIG. 5, light source 108 and resistor 110 are mounted to circuit board 106, wherein light source 108 and resistor 110 are electrically connected as illustrated in FIG. 4. Those skilled in the art will recognize that circuit board 106 may be located elsewhere within housing 150, or eliminated altogether, without detracting from the scope of the present invention. The operation of embodiment 18″ is identical to that described with respect to embodiment 18′ of FIG. 3 in that light source 108 is automatically illuminated upon connection of end 14 of accessory connector 10 to voltage source 16, and remains illuminated until end 14 of connector 10 is disengaged from voltage source 16. Light source 108 is positioned relative to housing 150 such that light emitted from light source 108 illuminates an area outside of housing 110 beyond terminal structure 114, and may accordingly be used to illuminate the electrical port 20 of electrical device 22 to facilitate insertion of end 18 of connector 10 within port 20, and to serve as an aid in locating the connector end 18 of the accessory connector 10, in an otherwise dark environment.

While embodiment 18″ is illustrated in FIG. 5 as including light source 108 on the top portion of housing 150, the present invention contemplates that light source 108 may alternatively be located on the side or bottom of housing 150 adjacent to end 154. In any such alternative location, however, it is desirable to position light source 108 such that it casts light both laterally and radially away from housing 150 beyond terminal structure 114.

Referring now to FIG. 6, a partial front perspective view of another alternate embodiment 18′″ of the second end 18 of the accessory connector 10 of FIG. 1, in accordance with the present invention, is shown. Embodiment 18′″ includes a housing 200 receiving the conductor cable 12 at one end (not shown) and defining a terminal structure 206 at an opposite end 202. In one embodiment, housing 200 is molded from a conventional plastic material having electrically insulative properties, although the present invention contemplates forming housing 200 from other known materials or combination of other known materials. A pair of arms 208a and 208b extend outwardly away from housing 200 in a direction parallel with terminal structure 206. While arms 208a and 208b may include structure for locking housing 200 to port 20 of accessory 202, such structure does not form part of the present invention and is accordingly not included in FIG. 6.

Embodiment 18′″ is similar in some respects to embodiment 18′ illustrated in FIG. 3 in that housing 200 defines a well therein, between arms 208a and 208b, with light source 108 and resistor 110 (with or without circuit board 106) positioned in the bottom thereof and filled with a light transmissive material 204. Alternatively, light transmissive material 204 may be molded in a block surrounding terminal structure 206 and such assembly positioned in front of light source 108 (with or without circuit board 106) such that light from light source 108 illuminates light transmissive material 204. In any case, light transmissive material 204 may be any known material operable to maintain the circuit board 106 and terminal structure 206 in fixed positions, and to permit transmission of light therethrough. Light transmissive material 206 may be transparent, translucent, or at least partially opaque, and the choice of any such light transmission capability will generally be dictated by the light intensity requirements of the particular application of the lighted accessory connector 10, taking into consideration the color and intensity of light source 108 as well as the configuration of housing 200. The operation of embodiment 18′″ is identical to that described with respect to embodiment 18′ of FIG. 3 in that light source 108 is automatically illuminated upon connection of end 14 of the accessory connector 10 to voltage source 16, and remains illuminated until end 14 of connector 10 is disengaged from voltage source 16. While illuminated, light source 108 is operable to cast light through the light transmissive material 204 and outwardly away from end 202 of housing 200 about the terminal structure 206. Light emitted from the end 202 of connector end 18′″ thus illuminates an area outside of housing 200 about and beyond terminal structure 206, and may accordingly be used to illuminate the electrical port 20 of electrical device 22 to facilitate insertion of end 18 of connector 10 within port 20, and to serve as an aid in locating the connector end 18 of the accessory connector 10, in an otherwise dark environment.

Alternatively or additionally, housing 200 may include a light source 108 mounted within a protruded portion 210 of housing 200, as shown in phantom in FIG. 6. Protruded portion 210 may extend from a side of housing 200 as illustrated in FIG. 6, or may alternatively extend from a top, bottom or opposite side of housing 200. In any case, the light source 108 is oriented to cast light outward laterally, and to a lesser extent radially, from housing 200 and beyond terminal structure 206.

While the invention has been illustrated and described in detail in the foregoing drawings and description, the same is to be considered as illustrative and not restrictive in character, it being understood that only preferred embodiments thereof have been shown and described and that all changes and modifications that come within the spirit of the invention are desired to be protected.

What is claimed is:

1. An electrical accessory connector comprising:
a first end configured for electrical connection to a voltage source; and
a second opposite end electrically coupled to said first end and configured for electrical connection to an electrical device, said second end including a light source positioned to cast light away from said second end to illuminate such an electrical device, said light source illuminated by connection of said first end of said electrical accessory connector to said voltage source.

2. The electrical accessory connector of claim 1 further including an electrical cable extending between said first and second ends of said electrical accessory connector.

3. The electrical accessory connector of claim 2 wherein said second end of said electrical accessory connector includes first and second electrical terminals electrically connected to corresponding first and second electrical conductors of said electrical cable.

4. The electrical accessory connector of claim 3 wherein said light source includes at least one light emitting diode (LED) defining first and second electrical connections thereto;
and wherein said first electrical connection to said at least one LED is connected to said first electrical conductor of said electrical cable;
and wherein said second electrical connection to said at least one LED is connected to one end of a resistor having a second end connected to said second electrical conductor of said electrical cable.

5. The electrical accessory connector of claim 1 wherein said second end of said electrical accessory connector includes:
a housing defining a well therein;
at least one electrical terminal structure extending into said well;
an electrically insulating and light transmissive medium disposed within said well and defining a terminal end having said at least one electrical terminal extending therefrom;
and wherein said light source is disposed within said well, said light source casting light through said light transmissive medium and outwardly away from said terminal end thereof.

6. The electrical accessory connector of claim 5 further including an electrical cable extending between said first and second ends of said electrical connector, said electrical cable including at least one electrical accessory conductor connected to said at least one electrical terminal structure extending into said well.

7. The electrical accessory connector of claim 1 wherein said second end of said electrical accessory connector includes a housing having at least one electrical terminal extending from a terminal end thereof;
and wherein said light source is mounted to said housing and positioned relative to said housing such that said light source is operable to cast light away from said housing beyond said at least one electrical terminal.

8. The electrical accessory connector of claim 7 further including an electrical cable extending between said first and second ends of said electrical accessory connector, said electrical cable including at least one electrical conductor connected to said at least one electrical terminal within said housing.

9. The electrical accessory connector of claim 1 wherein said first end of said electrical accessory connector defines a terminal structure configured for connection to a lighter socket.

10. The electrical accessory connector of claim 9 wherein said lighter socket is carried by a motor vehicle;
and wherein said voltage source is a vehicle battery electrically connected to said lighter socket.

11. The electrical accessory connector of claim 9 further including an AC-to-DC converter having an AC input configured for electrical connection to an AC voltage source and a DC output electrically connected to said lighter socket;
and wherein said voltage source is said AC voltage source.

12. The electrical accessory connector of claim 1 wherein said first end of said electrical accessory connector is electrically connected to a DC output of an AC-to-DC converter having an AC input configured for electrical connection to an AC voltage source and wherein said voltage source is said AC voltage source.

13. An electrical accessory connector comprising:
a first terminal structure electrically connected to one end of an electrical cable and configured for electrical connection to a voltage source;
a second terminal structure electrically connected to an opposite end of said cable and including at least one electrical terminal configured for electrical connection to an electrical device; and
a light source positioned to cast light outwardly away from said second terminal structure and beyond said at least one electrical terminal, said light source illuminated by connection of said first terminal structure to said voltage source.

14. The electrical accessory connector of claim 13 wherein said light source includes at least one light emitting diode (LED) defining first and second electrical connections thereto;
and wherein said first electrical connection to said at least one LED is connected to a first electrical conductor of said electrical cable;
and wherein said second electrical connection to said at least one LED is connected to one end of a resistor having a second end connected to a second electrical conductor of said electrical cable.

15. The electrical accessory connector of claim 13 wherein said second terminal structure includes:
a housing defining a well with said at least one electrical terminal extending therein;
an electrically insulating and light transmissive medium disposed within said well and defining a terminal end having said at least one electrical terminal extending therefrom;
and wherein said light source is disposed within said well, said light source casting light through said light transmissive medium and outwardly away from said terminal end thereof.

16. The electrical accessory connector of claim 15 wherein said electrical cable includes at least one electrical conductor connected to said at least one electrical terminal within said well.

17. The electrical accessory connector of claim 13 wherein said second terminal structure includes a housing having at least one electrical terminal extending from a terminal end thereof;
and wherein said light source is mounted to said housing and positioned relative to said housing such that said light source is operable to cast light away from said housing and beyond said at least one electrical terminal.

18. The electrical accessory connector of claim 17 wherein said electrical cable includes at least one electrical conductor connected to said at least one electrical terminal within said housing.

19. The electrical accessory connector of claim 13 wherein said first terminal structure is configured for connection to a lighter socket.

20. The electrical accessory connector of claim 19 wherein said lighter socket is carried by a motor vehicle;
and wherein said voltage source is a vehicle battery electrically connected to said lighter socket.

21. The electrical accessory connector of claim 19 further including an AC-to-DC converter having an AC input configured for electrical connection to an AC voltage source and a DC output electrically connected to said lighter socket;
and wherein said voltage source is said AC voltage source.

22. The electrical accessory connector of claim 13 wherein said first terminal structure is electrically connected to a DC output of an AC-to-DC converter having an AC input configured for electrical connection to an AC voltage source;
and wherein said voltage source is said AC voltage source.

23. An electrical accessory connector comprising:
a first end configured for electrical connection to a voltage source; and
a second opposite end electrically coupled to said first end and configured for electrical connection to an electrical device, said second end including a light source positioned to cast light away therefrom to illuminate said second end, said light source illuminated by connection of said first end of said electrical accessory connector to said voltage source.

24. The electrical accessory connector of claim 23 further including an electrical cable extending between said first and second ends of said electrical accessory connector.

25. The electrical accessory connector of claim 4 wherein said second end of said electrical accessory connector includes first and second electrical terminals electrically connected to corresponding first and second electrical conductors of said electrical cable.

26. The electrical accessory connector of claim 25 wherein said light source includes at least one light emitting diode (LED) defining first and second electrical connections thereto;
and wherein said first electrical connection to said at least one LED is connected to said first electrical conductor of said electrical cable;
and wherein said second electrical connection to said at least one LED is connected to one end of a resistor having a second end connected to said second electrical conductor of said electrical cable.

27. The electrical accessory connector of claim 23 wherein said first end of said electrical accessory connector defines a terminal structure configured for connection to a lighter socket.

28. The electrical accessory connector of claim 27 wherein said lighter socket is carried by a motor vehicle;
and wherein said voltage source is a vehicle battery electrically connected to said lighter socket.

29. The electrical accessory connector of claim 27 further including an AC-to-DC converter having an AC input configured for electrical connection to an AC voltage source and a DC output electrically connected to said lighter socket;
and wherein said voltage source is said AC voltage source.

30. The electrical accessory connector of claim 23 wherein said first end of said electrical accessory connector is electrically connected to a DC output of an AC-to-DC converter having an AC input configured for electrical connection to an AC voltage source
and wherein said voltage source is said AC voltage source.
